(19) United States
(12) Patent Application Publication
(10) Pub. No.: US 2001/0037243 A1
(43) Pub. Date: Nov. 1, 2001

(54) System and method for redeeming frequent flyer miles

(76) Inventors: W. Graeme Rouston, Miramar, FL (US); Brenda McGee, Sherman Oaks, CA (US); Bruce Schragin, Toluca Lake, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/828,255

(22) Filed: Apr. 6, 2001

Related U.S. Application Data
(60) Provisional application No. 60/198,846, filed on Apr. 21, 2000.

(51) Int. Cl. G06F 17/60

(52) U.S. Cl. 705/14; 705/5

(57) ABSTRACT

The invention is directed toward a system and method for redeeming frequent flyer miles for use in connection with business travel, and for providing incentives to employees who use frequent flyer miles for business travel. In one embodiment, the system and method are carried out over a computer network, for example the Internet.

### CROSS-REFERENCE TO RELATED APPLICATIONS

This application claims the benefit of U.S. provisional patent application 60/198,846, filed Apr. 21, 2000, the contents of which are hereby incorporated by reference.

### FIELD OF THE INVENTION

This invention relates generally to systems and methods for redeeming airline frequent flyer miles. More particularly, the invention relates to a system and method for redeeming frequent flyer miles for use in connection with business-related travel to the benefit of the employer, while providing incentives to the employee for using frequent flyer miles for business-related travel.

### BACKGROUND OF THE INVENTION

Most large commercial airlines offer bonuses to consumers when they fly on their particular airline. These bonuses frequently take the form of credits, commonly referred to as frequent flyer miles, that the consumer may use toward the issuance of tickets for future flights. The consumer typically earns miles by becoming a member of the airline's frequent flyer program and buying tickets for one or more of the airline's flights. The consumer may receive one or more frequent flyer miles for every actual air mile traveled. Mileage may also be earned through other sources, such as credit cards, long distance services, grocery store purchases, and the like. Once the consumer has accumulated sufficient miles in his or her account, the consumer can redeem some portion or all of those miles for tickets or upgrades for future flights.

Frequent flyer miles have no formal monetary value, typically cannot be exchanged between memberships in other airlines' frequent flyer programs unless an alliance between the airlines exist, and in some cases expire after a predetermined length of time. Some companies provide credit toward personal purchases and magazine subscriptions in exchange for trading in frequent flyer miles; however, such programs are quite limited in scope.

A large number of frequent flyer miles are earned during business travel. In most cases, those who are awarded frequent flyer miles subsequently use them to save on airline tickets or upgrades for personal use. Thus, employers often pay full fare for business-related tickets, and then the employees use the earned frequent flyer miles to receive large discounts, or even free tickets for personal use.

Therefore, a need exists for a system and method that provides incentives to employees to redeem frequent flyer miles for business travel, thereby allowing their employers to obtain cost-saving benefits through frequent flyer miles earned from business-related travel, as well as the employee's personal travel.

### SUMMARY OF THE INVENTION

The present invention provides a system and method for redeeming frequent flyer miles for use in connection with business travel, and for providing incentives to employees who use frequent flyer miles for business travel. In one embodiment, the system and method are carried out over a computer network, for example the Internet.

The system includes, in an exemplary embodiment, a central server adapted for communication with a plurality of clients (e.g., employers) and members (e.g., employees) over a computer network. In addition, the server is adapted for communication with one or more airline servers. The central server maintains account information for the respective clients and members, and credits a member's account upon completion of a business trip in which frequent flyer miles were used for business travel, after a member has entered the required information. Those credits may then be used by the member for personal airline travel or for other goods and/or services.

In one illustrative embodiment, the system communicates with clients, members, and partners over a wide area network, such as the Internet or the like. Alternatively, the system may communicate with its partners, clients, and/or members over private communication channels, or via any other suitable link.

In another illustrative embodiment, the invention is directed to a method of redeeming frequent flyer miles by a member, including redeeming a selected number of frequent flyer miles to receive a free or discounted airline ticket for business-related travel, and receiving corresponding remuneration based on the number of frequent flyer miles used.

### BRIEF DESCRIPTION OF THE DRAWINGS

These and other features of the invention will be better understood with reference to the following detailed description in conjunction with the accompanying drawings, wherein:

FIG. 1 is a schematic block diagram of one illustrative embodiment of a system for redeeming frequent flyer miles according to the present invention;

FIG. 2 is a flowchart depicting the operational flow involved in creating client and member accounts with a central system of the present invention;

FIG. 3 is a flowchart depicting the operational flow involved in redeeming frequent flyer miles using the central system of the invention;

FIG. 4 is a flowchart depicting additional steps involved in redeeming frequent flyer miles; and

FIG. 5 is a flowchart illustrating the steps involved in creating a client account for a company.

### DETAILED DESCRIPTION OF THE INVENTION

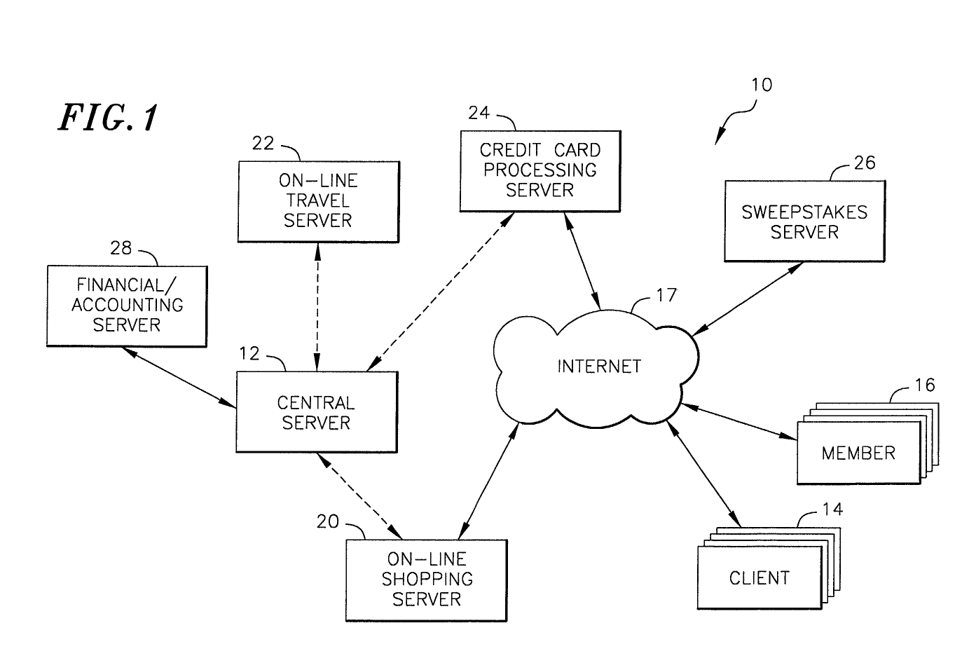

Referring to FIG. 1, a system 10 for redeeming airline frequent flyer miles is shown, according to one illustrative embodiment of the present invention. System 10 includes a central server 12 that is designed to interface with plural clients 14 and members 16 over a two-way communication network, such as the Internet 17. Central server 12 is designed to create accounts, and maintain account information, for the respective clients (also referred to as “employers” or “companies”) 14 and members 16 (also referred to as “employees”) Server 12 is also designed to process information relating to frequent flyer mile redemptions for business-related travel, and to credit the corresponding member's account, as is described in more detail below.

Central server 12 maintains at least one account for each member 16. The account preferably includes balance information relating to the number of frequent flyer miles earned by the member 16 in connection with business and/or personal travel. This provides one convenient location in which the member 16 can keep track of their earned frequent flyer miles. In one embodiment, the account also maintains credit information, namely the number of credits earned by the member based on redemptions of frequent flyer miles for business-related travel.

In one embodiment, each member 16 is responsible for providing information to central server 12 regarding the number of frequent flyer miles earned by that member, with such information being recorded in the member's account. In an alternate embodiment, central server 12 may communicate directly with one or more airlines to receive frequent flyer mile information for its respective members. Alternatively, such information may be maintained at the member's machine, with the account maintained by central server 12 storing credit balances based on redeemed frequent flyer miles.

Preferably, each client 14 (through a system administrator) may have access to its employees' accounts maintained by central server 12.

In one embodiment, system 10 communicates with the respective clients 14 and members 16 over the Internet 17. However, it will be apparent to those skilled in the art that system 10 may operate over any suitable communications network, such as a local area network (LAN), wide area network (WAN), wireless network, or any other network that allows for the bidirectional communication of data.

In one illustrative embodiment, system 10 further includes a number of additional servers to carry out various functions associated with the present invention. In one embodiment, system 10 includes an on-line shopping server 20 that maintains accounts for the respective members 16 and offers goods and/or services available for purchase on-line by exchanging credits in the members' accounts. Those accounts are credited, at least in part, based on information received from central server 12, which transmits member information to the shopping server 20, either over the Internet 17 or via a private link between the two servers. The shopping server 20 then establishes an account for the member(s), and may provide some initial incentive for establishing the account(s). Such member information may be transferred via email or file transfer protocol (FTP). The shopping server 20 then generates emails in a mail server or the like to the members informing them of the creation of their accounts.

As is described in more detail below, a member 16 may redeem credits in their account maintained by central server 12 for shopping credits. In that case, server 12 preferably utilizes an application programming interface (i.e., a gateway) between server 12 and shopping server 20 to transmit corresponding information to server 20, as is described in more detail below.

System 10 also includes an on-line travel server 22 that authorizes personal airline purchases for a member 16 based on a satisfactory number of credits being exchanged by member 16. Travel server 22 may be contacted by member 16 directly, or member 16 can interface with server 12, with server 12 then contacting travel server 22, all of which is described in more detail below.

Central server 12 also interacts with a credit card processing server 24, which processes member credit card information based on a redemption of frequent flyer miles for business-related travel, as is described in more detail below.

In one illustrative embodiment, the central server 12, on-line shopping server 20, travel server 22, and credit card processing server 24 are connected for communication over a private, back-end network (as shown by dashed lines in FIG. 1). The back-end network is not accessible by users via the Internet 17, and thus data and other information can be transmitted over back-end network without the need for encryption of that data, and without concern of interception of the data by unauthorized personnel.

A sweepstakes server 26 may also be provided to provide promotional awards to certain members 16 that use system 10. For example, a particular member 16 may receive one entry in the sweepstakes each time they redeem frequent flyer miles for business travel. Server 12 maintains a record of such information and periodically transfers such information to sweepstakes server 26. Each entry may include the member's name and email address. Winners may then be drawn randomly by server 26, and notified by email or any other suitable method(s).

System 10 also includes financial/accounting services, which may be handled by server 12, or alternatively by a separate financial/accounting server 28 (as shown in FIG. 1). Server 28 maintains account information, such as a log of transactions by a member, account balance information, and the like. In addition, server 28 may generate reports for various member accounts. In one embodiment, system 10 incorporates an Oracle Financial Accounting System or a similar Accounting System.

Central server 12 performs a number of functions, each of which may be separately handled by a dedicated server. Thus, while for convenience server 12 is depicted and described as a single server, it will be understood that it may consist of a plurality of servers, each designed to handle a specific function. In addition, while shopping server 20, travel server 22, credit card processing server 24, and sweepstakes server 26 are shown and described as separate from central server 12, it will be understood that some or all of the various functions can be carried out by central server 12.

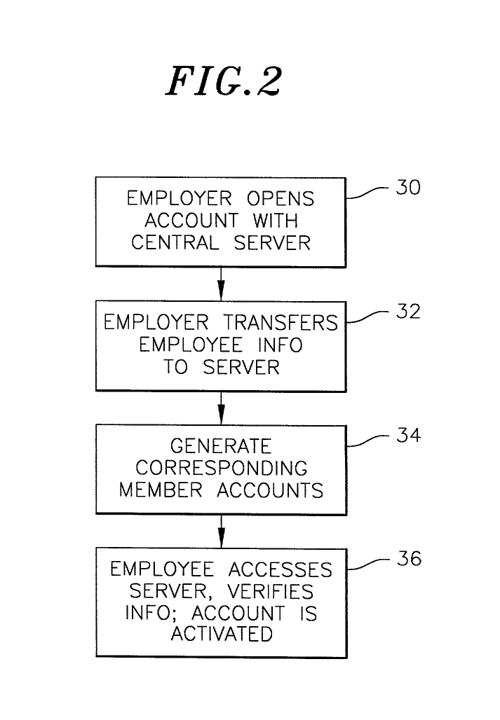

Referring now to FIG. 2, operation of system 10 in creating accounts for various clients and members is described in more detail. Operation begins at step 30, with a client 14 creating an account with server 12. In one embodiment, information is entered into server 12 by a server administrator. Alternatively, the client may access server 12 and enter the necessary information directly. The client information may include the company's name, address, contact information, and the like. Server 12 then saves the data in its database, generates client-specific identification information (e.g., a user name and password), and may also create a specific URL for that client to use in the future to access server 12.

Operation then proceeds to step 32, and client 14 transfers employee information to server 12, preferably as a batch transfer. Such information may include member's names, work information (job title and the like), credit card information, frequent flyer account numbers, and the like.

Then, at step 34, server 12 creates a member account for each employee of client 14. Once an account is generated, server 12 informs each member 16 that an account has been created for them and that their account requires activation. Such notification may be made by email, regular mail, or through any other suitable manner.

It will be understood that new members can be added at any time. A client 14 may inform server 12 that it has hired new employees, and can transfer the appropriate employee information to server 12, which then creates new member accounts and notifies the new members that those accounts have been created but require activation.

Operation then proceeds to step 36, and an email or other notifier is generated by server 12 and sent to the employees provided by client 14. The email preferably includes a user name and password. Then, one (or more) of the employees accesses server 12 and verifies the information contained in their account(s). Employees may edit and/or update the information in their accounts, including their user names, passwords, and the like. Once the employee indicates that the information is correct and agrees to any terms and/or conditions required by server 12, the employee becomes a member and their account is activated (hereinafter employees will be referred to as “members”)

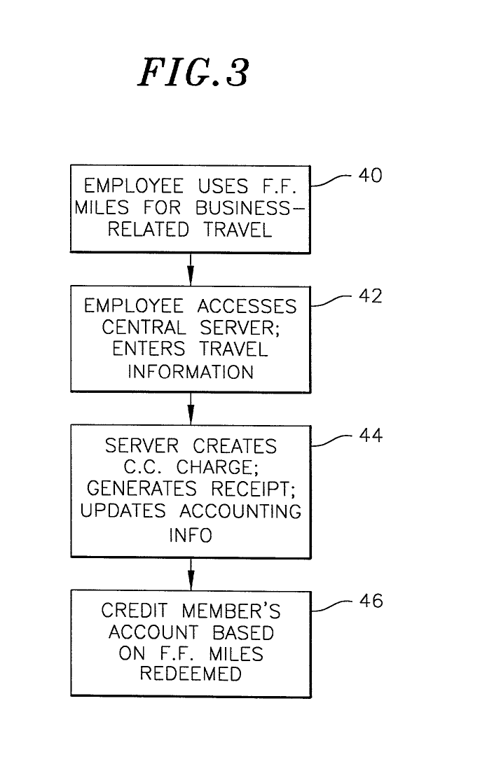

Referring now to FIG. 3, operation of system 10 in processing a redemption of frequent flyer miles is described in more detail. Operation begins at step 40, with a member 16 using their frequent flyer miles in connection with business-related travel. For example, a member may use 25,000 frequent flyer miles to obtain a free-(or discounted) airline ticket.

Operation then proceeds to step 42, and member 16 accesses server 12, either after completing travel or after purchasing the ticket. Member 16 logs in by providing their user name and password information, and then enters appropriate information pertaining to the frequent flyer mile redemption. The appropriate information may include the number of frequent flyer miles redeemed, the cost of the ticket, and the like.

Then, at step 44, once approved by member 16, server 12 creates a charge to the member's credit card, which is preferably processed by credit card processing server 24. A travel receipt is generated by server 12, which may be used by member 16 when submitting an expense report to the employer (client 14). In addition, corresponding financial accounting information is generated and stored, either by server 12 or by separate financial/accounting server 28.

Operation then proceeds to step 46, and server 12 credits the member's account by an amount based on the number of miles redeemed, or alternatively based on the amount of the airline ticket (e.g., the amount of the discount received). In addition, server 12 may generate a sweepstakes entry for member 16 and store the entry in memory for subsequent transfer to sweepstakes server 26 for entry into a sweepstakes drawing or the like. As described above, the drawing may be carried out by server 12, or by a separate sweepstakes server 26.

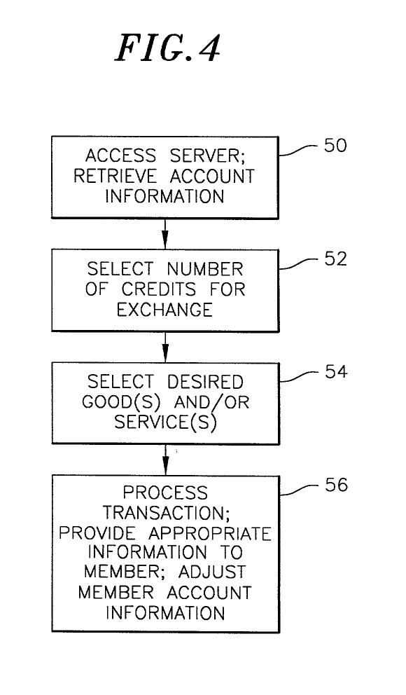

Referring now to FIG. 4, operation of system 10 in exchanging credits for goods and/or services is described in more detail. Operation begins at step 50, with member 16 accessing server 12 and retrieving their account information. Typically, member 16 enters their user name and password to gain access to their account information.

Then, at step 52, member 16 submits a request to redeem some number of the credits in their account. In one embodiment, server 12 provides the member 16 with the options of choosing to exchange credits for on-line shopping, or for air travel, or alternatively for virtually any good or service.

At step 54, member 16 selects the desired good and/or service they wish to receive. As described above, member 16 may exchange their credits for airline tickets for personal use, for merchandise available from the on-line shopping site 20, or virtually any other item.

At step 56, server 12 processes the request, and debits the member's account information by the number of credits being exchanged. Appropriate information is provided to the member 16, such as the URL of the travel server 22 or shopping server 20, the phone number of a person to contact at the travel partner to exchange the credits, or the like, along with a valid authorization number corresponding to the number of credits exchanged. Alternatively, the member's browser can be automatically directed to the appropriate web site corresponding to the travel server 22 or on-line shopping server 20. In addition, server 12 provides the necessary data to the shopping server or travel server. For example, server 12 may transmit a message to shopping server 20 so that the member's shopping account that is maintained by shopping server 20 can be updated by the amount of credits being exchanged.

As described above, rather than providing separate shopping and travel servers, server 12 may also handle the exchange of credits for goods and/or services. In addition, while the credits are described herein as being redeemable primarily for merchandise and/or personal airline tickets, it will be understood that the credits may be used for virtually any benefit. For example, employees of certain clients 14 may redeem a selected number of frequent flyer miles for a business-related airline ticket, and be awarded one or more vacation days, or any other benefit as decided on a client-by-client basis.

It will be understood that the credits in a member's account can expire after some predetermined period of time. In addition, a client 14 can access server 12 and select an option to extend the expiration date for its members' credits. Moreover, server 12 may be designed to automatically generate notifications (by email or otherwise) some amount of time prior to expiration of a member's credits.

Server 12 is preferably designed to function as an interface with clients 14 and members 16 that access server 12 from respective user terminals. Thus, server 12 generates the front end that is presented to each client and member. In addition, server 12 manages various other client interactions, including account management, user authentication (through passwords or other information), and the like, all of which is well understood in the art.

In an exemplary embodiment, server 12 generates a number of web pages for presentation to clients and members, includes a splash page, a home page, information pages, and pages for enrolling into the system and logging into accounts maintained by server 12. Once a member 16 accesses his or her account, he or she may enter travel information to update their account balance, shop on-line, or modify his or her account through sets of web pages dedicated to those functions.

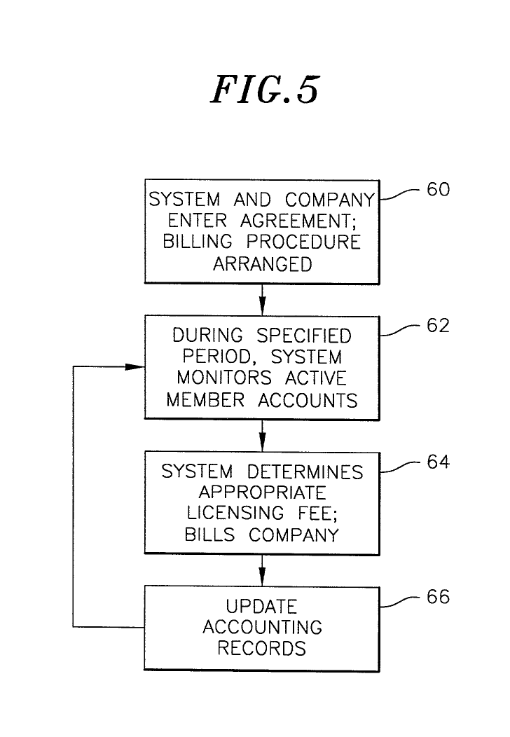

Referring now to FIG. 5, the operation of establishing a relationship between system 10 and a company or other employer (hereinafter “company”) is described in more detail. Operation begins at step 60, with the company entering into an agreement by which system 10 will create accounts for the company's employees, as is described in detail above. The agreement between system 10 and the company (which becomes a client 14 of system 10) preferably includes a payment arrangement for payment of a periodic fee by the new client 14. In one embodiment, client 14 pays a monthly licensing fee to system 10 based on the number of employee accounts maintained by system 10. The fee can be based on the total number of accounts, or on only those accounts that are active during the specified period (e.g., during a one-month period). Alternatively, client 14 may be charged a fixed monthly fee regardless of the number of employee accounts maintained by system 10. An exemplary template agreement is attached hereto as Exhibit A.

System 10 then creates a client account for the new client 14, and selects the appropriate billing procedure based on the agreement between system 10 and client 14. For example, the appropriate billing procedure may be to charge the client 14 $1.00 per month per active employee account.

Operation then proceeds to step 62, and central server 12 monitors the active member accounts for each client 14. Preferably, each member account will include information associating that account with a particular client 14. Server 12 determines the number of active member accounts for each client 14 within a predetermined period, such as once every month. Alternatively, for those clients 14 that have fixed fee arrangements, there is no need to track the number of active member accounts.

Then, at step 64, central server 12 charges a client 14 a fee based on the number of active member accounts or, alternatively, based on a fixed-fee arrangement between system 10 and client 14. An invoice may be generated electronically by central server 12 and distributed by email or other suitable means. Alternatively, the invoices can be generated manually by a system administrator and distributed by mail, fax, or the like.

Operation then proceeds to step 66, and server 12 updates its accounting information to reflect the transaction. Operation then proceeds back to step 62 to monitor active member accounts for the subsequent period.

Thus, income is generated by system 10 based on licensing fees paid by clients 14. In addition, system 10 may receive referral fees from merchants by directing its members 16 to those merchants' web sites. System 10 may also share in the proceeds from any purchases made by the members 16 through those merchants.

In yet another embodiment, system 10 may contract with third parties in order to acquire new clients 14. For example, a system administrator may enter into an agreement with a travel agency, whereby if any of the travel agency's clients (also referred to as “end users”) become clients 14 of system 10, the travel agency will receive a portion of the licensing fees paid to system 10 by those clients. An exemplary licensing agreement is attached hereto as Exhibit B. Those skilled in the art will understand that such agreements can be entered into with various third parties, and not only travel agents.

As used herein, the term “server” is defined as either a computer program run by a computer to perform a certain function, a computer or device on a network that is programmed to perform a specific task (e.g., a database server), or a single computer that is programmed to execute several programs at once, and thereby perform several functions. Thus, the term “server” refers to either a program that is performing a function, or a computer dedicated to performing one or more such functions.

From the foregoing, it will be apparent to those skilled in the art that the present invention provides a system and method for redeeming frequent flyer miles for business-related travel, in which both the employer and employee derive a benefit.

Although described in the context of a presently preferred embodiment, those skilled in the art will realize that various modifications may be made to the system and method without departing from the spirit and scope of the present invention. For example, the present invention is not limited to airline frequent flyer miles, but may be used in connection with other types of reward programs, such as reward programs for hotels, car rentals or other products or services.

1. A method of redeeming airline frequent flyer miles by an employee of an employer, comprising:
accruing a number of frequent flyer miles;
redeeming a selected number of the frequent flyer miles to receive a benefit in connection with a business-related airline ticket purchase; and
receiving a corresponding incentive.

2. The method of claim 1, further comprising creating an account for the employee, and wherein receiving a corresponding incentive comprises crediting the employee's account.

3. The method of claim 2, further comprising recording accrued frequent flyer mile information in the respective employees' accounts.

4. The method of claim 2, wherein crediting the employee's account comprises crediting the account by an amount based on at least one of the number of frequent flyer miles redeemed and the amount of the benefit received.

5. The method of claim 1, wherein receiving a corresponding incentive comprises receiving at least one of a voucher for airline travel, credits for airline travel, and credits that can be exchanged for goods and/or services.

6. The method of claim 1, further comprising charging the employee's credit card an amount corresponding to the number of frequent flyer miles redeemed.

7. The method of claim 2, further comprising creating an account for each employer, and billing the employer's account based on the number of existing employee accounts.

8. The method of claim 7, further comprising entering an agreement with a third party, creating accounts for the employers referred by the third party, and compensating the third party.

9. The method of claim 1, wherein accruing frequent flyer miles comprises accruing at least one of personal and business-related frequent flyer miles.

10. The method of claim 1, wherein redeeming a selected number of the frequent flyer miles comprises redeeming a sufficient number of the frequent flyer miles to receive a discount on a business-related airline ticket purchase.

11. The method of claim 1, wherein redeeming a selected number of the frequent flyer miles comprises redeeming a sufficient number of the frequent flyer miles to receive a free or upgraded business-related airline ticket.

12. A method for redeeming airline frequent flyer miles by an employee of a company, comprising:
creating a client account for the company;
receiving employee-related data from the company;
creating member accounts for the respective employees of the company;
receiving information relating to a redemption of a selected number of frequent flyer miles by an employee in connection with a business-related airline ticket purchase; and
providing a corresponding benefit to the appropriate member account.

13. The method of claim 12, wherein providing a corresponding benefit comprises crediting the employee's member account with a number of credits.

14. The method of claim 13, wherein crediting the employee's account comprises crediting the account by an amount based on at least one of the number of frequent flyer miles redeemed and the amount of the benefit received.

15. The method of claim 12, wherein providing a corresponding benefit comprises providing at least one of a voucher for airline travel, credits for airline travel, and credits that can be exchanged for goods and/or services.

16. The method of claim 12, further comprising charging the employee's credit card an amount corresponding to the number of frequent flyer miles redeemed.

17. The method of claim 12, further comprising billing the employer's account on a periodic basis based on the number of existing member accounts.

18. The method of claim 12, wherein receiving information comprises receiving information relating to the redemption of a sufficient number of the frequent flyer miles to receive a discount on a business-related airline ticket purchase.

19. The method of claim 12, wherein receiving information comprises receiving information relation to the redemption of a sufficient number of the frequent flyer miles to receive a free business-related airline ticket.

20. The method of claim 12, further comprising recording accrued frequent flyer mile information in the respective members' accounts.

21. The method of claim 12, further comprising entering an agreement with a third party, creating client accounts for companies referred by the third party, and compensating the third party.

22. A system for processing information relating to frequent flyer mile redemptions, the system comprising:
an interface to communicate over a communication network;
a processor that is programmed to create a plurality of member accounts, and is operative in response to the receipt of frequent flyer mile redemption information by one of the members to credit the corresponding member account.

23. The system of claim 22, wherein the processor is programmed to process a request by a member to exchange credits, generate appropriate exchange information, and update the member's account.

24. The system of claim 23, wherein the processor is operative to communicate with at least one of a shopping server and travel server relating to an exchange of credits by a member.

25. The system of claim 23, wherein the processor is operative to communicate with a credit card processing server in connection with a redemption of frequent flyer miles by a member.

26. The system of claim 22, wherein the processor is operative to create a client account for a company, and to receive employee-related information from the company to create the member accounts.

27. The system of claim 22, wherein the processor is operative to create a plurality of member accounts based on employee-related information received, and to interact with the respective members to activate said member accounts.

28. The system of claim 27, wherein the processor is programmed to record accrued frequent flyer mile information in the respective members' accounts.
